(19) United States
(12) Patent Application Publication
(10) Pub. No.: US 2007/0109197 A1
(43) Pub. Date: May 17, 2007

(54) Fixed tiltable antenna device

(75) Inventors: Robert Schilling, Londonderry, NH (US); Thomas Sherman Laubner, Merrimac, MA (US)

Correspondence Address: Tyco Technology Resources, Suite 140, 4550 New Linden Hill Road, Wilmington, DE, 19808-2952, US

(73) Assignee: M/A-COM, Inc.

(21) Appl. No.: 11/486,681

(22) Filed: Jul. 14, 2006

Related U.S. Application Data
(60) Provisional application No. 60/699,673, filed on Jul. 15, 2005.

(51) Int. Cl. H01Q 1/38

(52) U.S. Cl. 343/700 MS; 343/872

(57) ABSTRACT

An antenna device includes a directional antenna and a support member that supports the antenna. The support member includes one or more fixed supports on which the antenna device can be placed to provide for a desired antenna reception beam elevation angle.

### RELATED APPLICATIONS

This application claims the benefit under of U.S. Provisional Application No. 60/699,673, filed on Jul. 15, 2005.

### FIELD OF THE INVENTION

The invention relates generally to antenna devices. The invention relates more particularly to fixed tiltable enclosures for antenna devices.

### BACKGROUND OF THE INVENTION

In the past, antenna devices for receiving have included relatively complex mechanisms for adjusting position, orientation, elevation, etc. to focus the direction of transmission and/or reception. For example, elevation adjustment mechanisms have been incorporated into radio-frequency (RF) satellite antenna designs to allow better focusing of the antenna to the area of the sky where the satellite(s) are located. This has been necessary because the reception beam of the antenna is narrower than that area of the sky that the satellite(s) occupy when considering all geographical locations of utilization. For example, an antenna may be required to receive signals from systems having fixed geostationary satellites. The position of the satellites in the sky can vary in elevation from 20 degrees to 60 degrees from the horizon depending on where, geographically, the antenna is located. As a result, depending on the geographic location of the antenna, the elevation of the antenna may need to be adjusted to achieve proper focus on the satellites.

As such, home antenna modules, or fixed location antenna modules normally provide for an elevation adjustment mechanism to focus the reception beam (for example, where the signal is most efficiently received) in the direction of the satellite. In azimuth, the antenna is simply oriented in position. This elevation mechanism typically includes a base for the antenna and an enclosure for the antenna element and a low-noise amplifier (LNA). The enclosure is attached to the base having a hinge mechanism that ratchets or is fixable at a desired elevation angle within the range prescribed by the application. This mechanism adds to the complexity, size, and cost of the unit.

Accordingly, there is a need for relatively simple antenna devices to provide for a desired orientation of the antenna. There also is a need for simple antenna devices that provide for multiple selectable desired antenna reception beam elevation angles.

### BRIEF SUMMARY OF THE PREFERRED EMBODIMENTS

According to one aspect of the invention, there is an antenna device. The antenna device includes an antenna and an enclosure supporting the antenna. The enclosure includes one or more fixed faces on which the antenna device can be placed to provide for the reception of electromagnetic signals by the antenna at a desired elevation angle.

According to another aspect of the invention, there is another antenna device. The antenna device includes an antenna and a support member supporting the antenna. The support member includes one or more fixed supports on which the antenna device can be placed to provide for the reception of electromagnetic signals by the antenna at a desired elevation angle.

Other devices, systems, methods features, and advantages of the invention will be, or will become, apparent to one with skill in the art upon examination of the following figures and detailed description. It is intended that all such additional systems, methods, features and advantages be included within this description.

### BRIEF DESCRIPTION OF THE DRAWINGS

The components in the figures are not necessarily to scale, emphasis instead being placed upon illustrating the principles of the invention. Moreover, in the figures, like referenced numerals designate corresponding parts throughout the different views.

FIGS. 1a-h provide multiple views of an antenna device with four faces in accordance with an exemplary embodiment of the present invention;

FIGS. 2a-b provide multiple views of an antenna device with two faces in accordance with an exemplary embodiment of the present invention;

FIGS. 3-10 provide multiple different views of the antenna device illustrated in FIGS. 2a-b; and

FIG. 11 illustrates a backside view of the antenna and circuit board positioned in the radome portion according to another embodiment of the present invention.

### DETAILED DESCRIPTION OF THE PREFERRED EMBODIMENTS

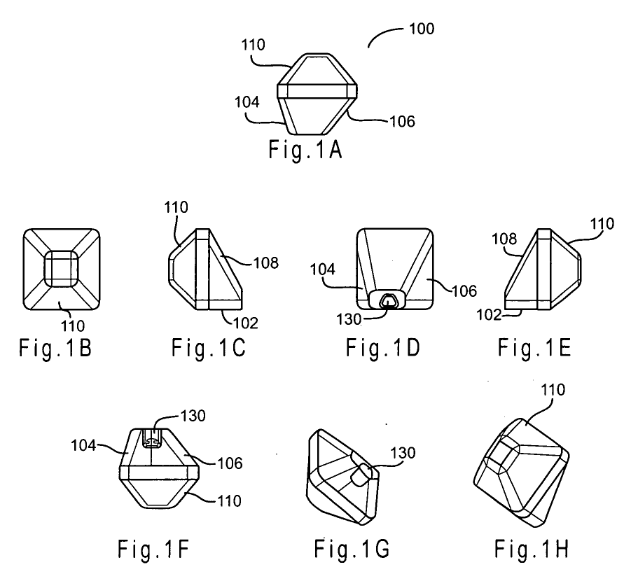

Embodiments of the invention include antenna devices including an antenna and one or more fixed supports on which the antenna device can be placed to provide for a desired antenna reception beam elevation angle. The antenna devices provide for reception of electromagnetic signals at a desired elevation angle and may provide for multiple selectable elevation angles. The fixed supports may be formed as part of a support member that supports the antenna device. For example, the support member may be an antenna enclosure, and the fixed supports may be one or more faces on the enclosure on which the antenna device can be placed to provide for a desired antenna reception beam elevation angle. For purposes of illustration, an exemplary antenna device is illustrated in FIG. 1.

Antenna devices, provided in accordance with exemplary embodiments described herein, utilize the fact that the satellites reside and transmit signals over a fixed range of angles in elevation. For example, in accordance with an exemplary embodiment of the present invention, the angles that need to be properly covered for reception of certain satellite signals are from approximately 20 degrees to 60 degrees. In accordance with another exemplary embodiment of the present invention, the angles that need to be properly covered for reception of certain satellite signals are from approximately 50 degrees to 70 degrees. In accordance with yet another exemplary embodiment of the present invention, the antenna may need to be directed approximately at the zenith, or 90 degrees from the horizon. It should be apparent that other angle ranges could also be employed depending upon the type of satellite system that the antenna is required to receive.

Also, recognizing that the pointing accuracy of the antenna in elevation is not extremely critical, it is not necessary to have a multitude of elevation positions between the extremes of the satellite location. Rather, by breaking up this region into a number of subregions, the base of the antenna device requiring an adjustable hinge mechanism can be eliminated. Instead the antenna device can be designed to have a support member with one or more fixed supports, each at a particular angle with respect to the center of the directional antenna reception beam. For example, the directional antenna element may be supported inside an enclosure having one or more faces at particular desired angles with respect to the direction of the antenna reception beam. As a result, the desired reception beam elevation angle can be achieved simply by placing the antenna device on the desired fixed support. In the case of the full antenna enclosure, the desired reception beam elevation angle can be achieved by placing the antenna device on the desired enclosure face. If the device has multiple fixed supports or enclosure faces, a different elevation angle can be selected based upon the positioning the antenna device on a particular one of the fixed supports or enclosure faces.

For example, as illustrated in FIGS. 1A-H, a four-faced antenna device 100 can be employed. The four-faced antenna device 100 may be employed to cover antenna reception beam elevation angles from 0 to 60 degrees. Individual faces 102, 104, 106, 108 are designed to direct the antenna reception beam to cover different angles from the horizon. Face 102 is designed to center the antenna reception beam at an angle of approximately 0 degrees elevation (the horizon); face 104 is designed to center the antenna reception beam at an angle of approximately 20 degrees elevation from the horizon; face 106 is designed to center the antenna reception beam at an angle of approximately 40 degrees elevation from the horizon; and face 108 is designed to center the antenna reception beam at an angle of approximately 60 degrees elevation from the horizon.

As shown in FIG. 1A and FIGS. 1C-F, the faces 102, 104, 106,108 of antenna device 100 are arranged with the face 102 (0 degrees) opposite the face 108 (60 degrees). Similarly, the face 104 (20 degrees) is opposite the face 106 (40 degrees). With this arrangement, the antenna device 100 may be placed on any one of the four faces 102, 104, 106, 108 to achieve the desired elevation angle for the antenna reception beam.

The antenna device 100 also includes a radome 110. The radome 110 is illustrated in FIGS. 1A-C and FIGS. 1E-H. The radome 110 covers and protects the antenna inside the antenna device enclosure. The radome may be configured and shaped in any desired manner depending on the particular application. The antenna device 100 also may include a port 130 for connecting an antenna cable to the antenna inside the antenna device 100.

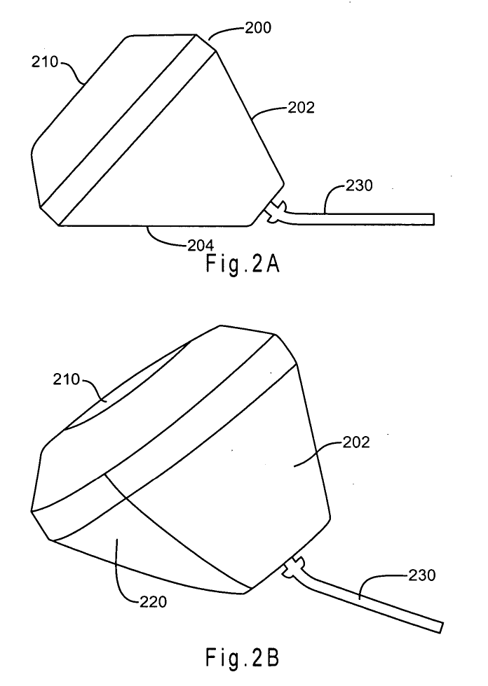

The antenna device 100 depicted in FIG. 1 includes four fixed enclosure faces, but other devices may include more or fewer enclosure faces, depending on the application. For example, if the range of required antenna reception beam elevation angles is narrow enough, an antenna device may include only a single fixed enclosure face. Alternatively, an antenna device may include two fixed enclosure faces, like the exemplary embodiment shown in FIGS. 2A-B.

As illustrated in FIGS. 2A-B, a two-faced antenna device 200 can also be employed. In this embodiment, two faces 202, 204 are designed to direct the antenna reception beam to cover different elevation angles from the horizon. Face 202 is designed to direct the antenna reception beam at an angle of approximately 20 degrees from the horizon; and face 204 is designed to direct the antenna reception beam at an angle of approximately 40 degrees from the horizon.

The faces 202, 204 of the antenna device 200 are arranged with the face 202 (20 degrees) opposite the face 204 (40 degrees). With this arrangement, the antenna device 100 may be placed on either of the two faces 102, 104 to achieve the desired elevation angle for the antenna reception beam. As illustrated in FIGS. 2a-b, the faces 202, 204 may be connected by smoothly curved portions 220 of the antenna device enclosure.

Like the antenna device 100, the antenna device 200 also includes a radome 210. The radome 110 covers and protects the antenna inside the antenna device enclosure. The radome may be configured and shaped in any desired manner depending on the particular application. The antenna device 200 also is shown with an antenna cable 230 for connecting the antenna device 200 to a receiver.

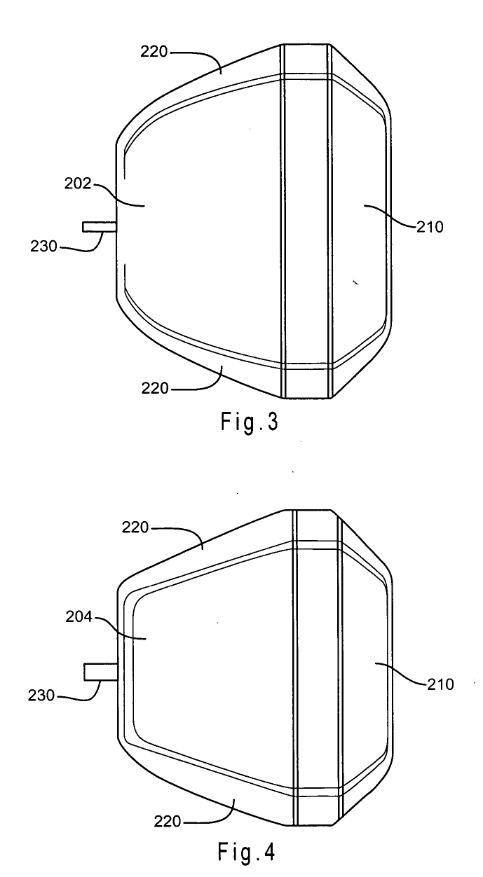

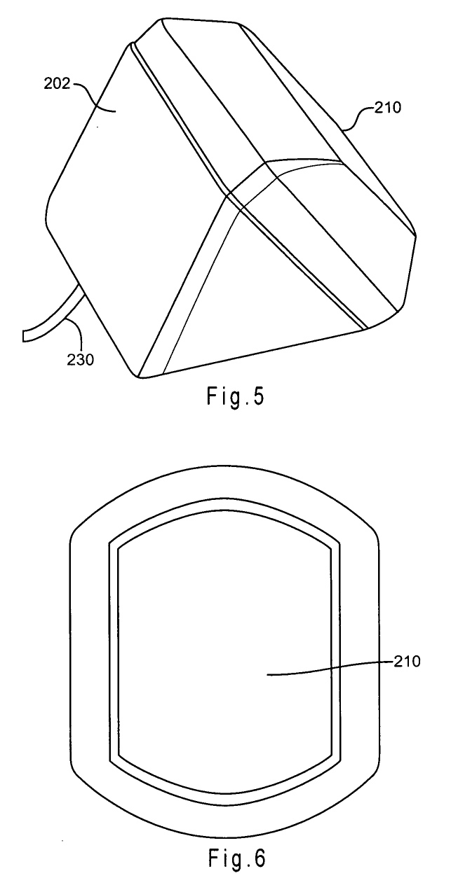

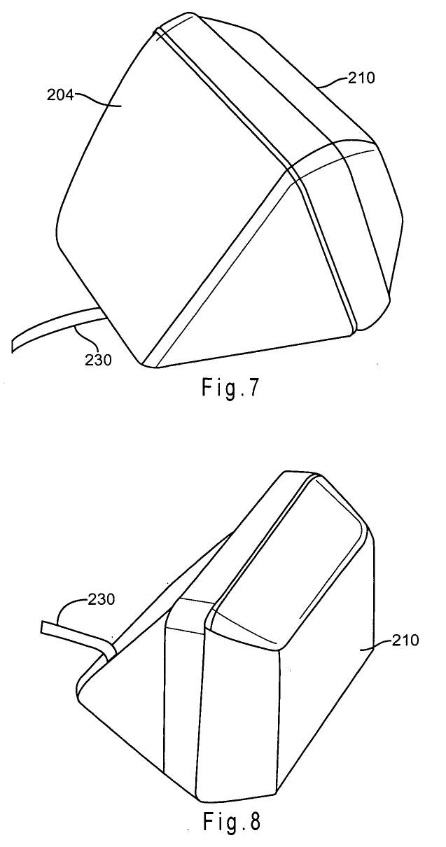

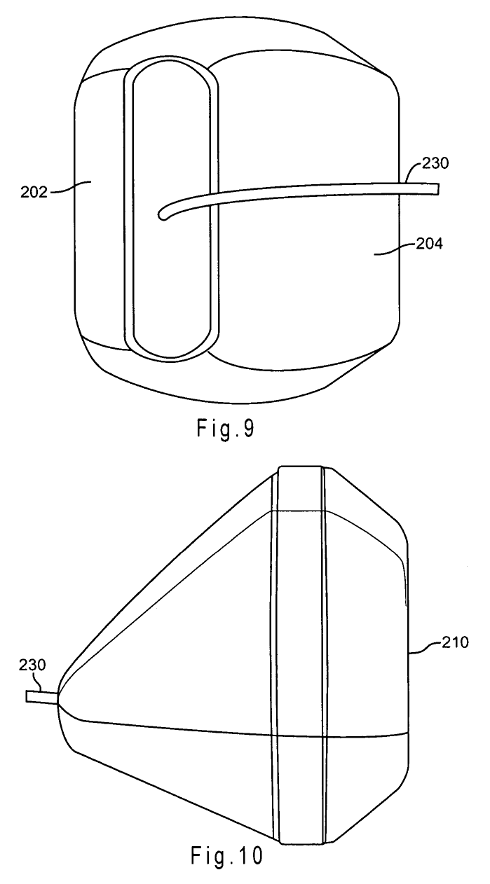

FIGS. 3-10 also depict the two-faced antenna device 200 from multiple different views. FIGS. 3 and 5 illustrate the antenna device 200 positioned on face 204 to provide an antenna reception beam elevation angle of approximately 20 degrees. Similarly, FIGS. 4, 7, and 8 illustrate the antenna device 200 positioned on face 202 to provide an antenna reception beam elevation angle of approximately 60 degrees.

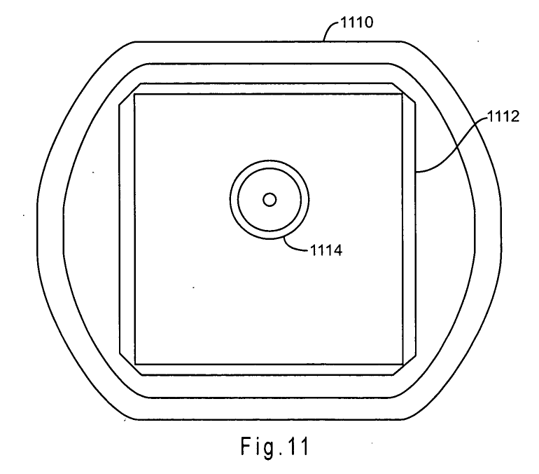

FIG. 11 illustrates a backside view of the antenna and internal circuit board 1112 positioned in the radome portion 1110 according to another embodiment of the present invention. The circuit board 1112 includes a connector 1114 for connecting an antenna cable inside the enclosure of the antenna device.

The antenna devices illustrated in FIGS. 1-11 include an enclosure with two separable parts; a back portion including the faces 102, 104, 106, 108, 202, 204 and a front radome portion 110, 210, 1110. The back portion, which includes the angled mount faces, can be made, for example, from a zinc die casting. As indicated above, each face of the back portion is individually designed at a particular angle with respect to the antenna reception beam, which extends perpendicularly from the front of the radome portion. As a result, the antenna device may be positioned on a particular one of the faces to provide a required antenna beam output angle.

The front radome portion can comprise a plastic material, made via injection molding, for example. Located inside the enclosure is a patch antenna, or the like. An electronics circuit board that can include a low-noise amplifier (LNA) and a band-pass filter can also be located within the enclosure. The patch antenna can be attached to the circuit board. In turn, the circuit board can be secured to the radome. The radome portion as illustrated in FIG. 11 (including the antenna and circuit board) can then be attached to the back portion of the enclosure.

Although the front radome portion and the back portion of the antenna devices 100, 200 illustrated in FIGS. 1 and 2 are separable parts, other designs are possible. For example, the front radome portion and the back portion may be integrally formed as a single unit. One of ordinary skill in the art will appreciate that other supporting enclosure designs are possible depending on the particular design parameters of the application. Additionally, while the antenna device herein has been described with a base portion having two and four faces, one could understand that a base portion having a different number of faces could also be employed.

In addition, the antenna device support need not entirely enclose the antenna. Instead, the support may take the form of a frame surrounding the antenna element and providing multiple separate framed supports at different angles with respect to the direction of the antenna reception beam. Like the multiple faces of the enclosures illustrated in FIGS. 1 and 2, the multiple supports of an alternative frame support member provide for different elevation angles of the antenna device. One of ordinary skill in the art will appreciate that other non-enclosing support member designs are possible depending on the design parameters of the application.

The antenna devices, as illustrated above, provide coverage for the fixed elevation angle(s) needed to cover and locate satellites. With regard to the embodiment illustrated in FIG. 2, the antenna device may be situated to operate based upon its geographical location (i.e., within the United States). The antenna device can be placed in a window sill or the like, as long as a clear path to the satellite is provided.

For example, in the northern United States, satellite antennas may be oriented at a relatively low elevation angle due to the position of the satellites in space. As a result, the antenna device may be situated on the face that orients the antenna reception beam at an elevation angle of 20 degrees. By contrast, in the southern United States, satellite antennas may be oriented at a higher elevation angle for proper focus. As a result, the antenna may be situated on the face that orients the antenna reception beam at an elevation angle of 40 degrees. Thus, the elevation angle of the antenna device may be adjusted to suit its geographic location without the need for a separate base, hinge, and fixing mechanism. A fixed support or face also may be provided on the antenna device at a position opposite that of the antenna reception beam. Placing the antenna device on this support or face provides reception approximately at the zenith, or 90 degrees from the horizon.

By providing one or more fixed supports or enclosure faces to support an antenna device, the size of the antenna device can be reduced, and the complexity of the antenna mount can be eliminated. This allows for a reduction in the cost of the antenna device and also provides for a more aesthetically pleasing package.

It is intended that the foregoing detailed description be regarded as illustrative rather than limiting, and that it be understood that the following claims, including all equivalents, are intended to define the scope of this invention.

1. An antenna device, comprising:
an antenna; and
an enclosure supporting the antenna, wherein the enclosure includes a plurality of fixed faces on which the antenna device can be placed to provide for the reception of electromagnetic signals by the antenna at a plurality of desired elevation angles.

2. An antenna device as in claim 1, wherein the antenna further comprises a patch antenna.

3. An antenna device as in claim 1, further comprising:
a radome portion covering the antenna.

4. An antenna device as in claim 1, wherein the plurality of fixed enclosure faces further comprises two fixed enclosure faces.

5. An antenna device as in claim 1, wherein at least one of the two fixed enclosure faces is angled to direct the antenna at an elevation angle between 20 degrees and 60 degrees.

6. An antenna device as in claim 1, wherein at least one of the two fixed enclosure faces is angled to direct the antenna at an elevation angle between 50 degrees and 70 degrees.

7. An antenna device as in claim 1, wherein the plurality of fixed enclosure faces further comprises four fixed enclosure faces.

8. An antenna device as in claim 7, wherein at least one of the four fixed enclosure faces is angled to direct the antenna at an elevation angle between 20 degrees and 60 degrees.

9. An antenna device as in claim 7, wherein at least one of the four fixed enclosure faces is angled to direct the antenna at an elevation angle between 50 degrees and 70 degrees.

10. An antenna device as in claim 1, wherein at least one of the four fixed enclosure faces is angled to direct the antenna at an elevation angle of approximately 90 degrees.

11. An antenna device, comprising:
an antenna; and
an enclosure supporting the antenna, wherein the enclosure includes a fixed face on which the antenna device can be placed to provide for the reception of electromagnetic signals by the antenna at a desired elevation angle between approximately 20 and 70 degrees.

12. An antenna device as in claim 10, wherein the fixed enclosure face is angled to direct the antenna at an elevation angle of approximately 20 degrees.

13. An antenna device as in claim 11, wherein the fixed enclosure faces is angled to direct the antenna at an elevation angle of approximately 40 degrees.

14. An antenna device as in claim 11, wherein the fixed enclosure face is angled to direct the antenna at an elevation angle of approximately 60 degrees.

15. An antenna device, comprising:
an antenna; and
a support member supporting the antenna, the support member including a fixed support on which the antenna device can be placed to provide for reception of electromagnetic signals by the antenna at a desired elevation angle between approximately 20 and 70 degrees.

16. An antenna device as in claim 15, wherein the support member further includes a plurality of fixed supports on which the antenna device can be placed to provide for reception of electromagnetic signals by the antenna at a plurality of different desired elevation angles.

17. An antenna device as in claim 16, wherein the plurality of fixed supports further comprises two fixed supports.

18. An antenna device as in claim 16, wherein the plurality of fixed supports further comprises four fixed supports.

19. An antenna device as in claim 16, wherein at least one of the plurality of fixed supports is angled to direct the antenna at an elevation angle between 20 degrees and 70 degrees.

20. An antenna device as in claim 16, wherein at least one of the plurality of fixed supports is angled to direct the antenna at an elevation angle of approximately 90 degrees.
